(19) United States
(12) Patent Application Publication
(10) Pub. No.: US 2015/0047491 A1
(43) Pub. Date: Feb. 19, 2015

(54) Guide Bar for a Saw Chain of a Motor-Driven Chain Saw and Application of a Marking on a Guide Bar of a Motor-Driven Chain Saw

(71) Applicant: Andreas Stihl AG & Co. KG, Waiblingen (DE)

(72) Inventor: Guenther Schamberg, Goeppingen (DE)

(73) Assignee: Andreas Stihl AG & Co. KG, Waiblingen (DE)

(21) Appl. No.: 13/965,857

(22) Filed: Aug. 13, 2013

(51) Int. Cl. B27B 17/02

(52) U.S. Cl. CPC B27B 17/02
USPC 83/875; 30/383

(57) ABSTRACT

A guide bar for a saw chain of a chain saw has a fastening section and a redirecting section. The guide bar has an imaginary longitudinal center axis extending from the fastening section to the redirecting section. The guide bar has at least one first marking in the form of a line. The first marking is inclined at an angle of about 20° to about 80° with respect to the longitudinal center axis when viewing the guide bar in side elevation. The first marking is used to estimate, during operation, the depth (t) of a groove produced by the saw chain in the workpiece in the case of a cut in which the longitudinal center axis of the guide bar is inclined at an angle of about 20° to about 80° to the surface of the workpiece.

### FIELD OF THE INVENTION

The invention relates to a guide bar for a saw chain of a chain saw and the use of a marking on a guide bar.

### BACKGROUND OF THE INVENTION

U.S. Pat. No. 5,054,206 discloses a marking on a guide bar which can be used to measure the diameter of a trunk to be sawed. The markings extend perpendicularly to the longitudinal center axis of the guide bar.

### SUMMARY OF THE INVENTION

The invention is based on the object of creating a guide bar for a saw chain of a chain saw which makes it possible to carry out precise work with the chain saw. A further object of the invention is to provide a method of using a marking on a guide bar of a chain saw which makes it possible to carry out precise work with the chain saw.

For the guide bar of a saw chain of a chain saw, provision is made for the guide bar to have a fastening section at one end and a redirection section at the opposite end, the guide bar having an imaginary longitudinal center axis which extends from the fastening section of the guide bar to the redirection section of the guide bar, the guide bar bearing at least one first marking, the first marking being in the form of a line, and the first marking being inclined at an angle of about 20° to about 80° with respect to the longitudinal center axis in side view of the guide bar.

The marking inclined with respect to the longitudinal center axis makes it possible to estimate the cut depth in the case of cuts in which the guide bar is not arranged perpendicularly, but rather in an inclined manner with respect to the workpiece surface. As a result, it is possible to produce a plurality of inclined incisions, for example from a number of sides, with the same depth in a workpiece. This is particularly advantageous when the guide bar is used for carving. Advantageously, at least one first marking is provided, the first marking being inclined at an angle of about 20° to about 70°, in particular of about 30° to about 60°, preferably about 40° to about 50°, with respect to the longitudinal center axis in side view of the guide bar.

The first marking is advantageously arranged in a front region of the guide bar, the front region extending from the redirection section of the guide bar along at most half the overall length of the guide bar. In particular in the case of a comparatively shallow cut depth or in the case of carving work, which is usually carried out with the front region of the guide bar, precise estimation of the incision depth is desirable. This is made possible by the first marking in the front region of the guide bar. In order to enable estimation which is as precise as possible of the cut depth at different inclination angles of the guide bar with respect to the workpiece surface, provision is advantageously made for the guide bar to have at least one further first marking, the first marking and the further first marking being inclined with respect to one another. The first marking and the further first marking advantageously enclose an angle of about 5° to about 40° with one another. It is also possible for a plurality of further first markings to be provided.

Advantageously, the first marking and the further first marking intersect at the longitudinal center axis of the guide bar. As a result, the same cut depth can be estimated at different inclination angles of the guide bar. However, it is also possible to provide for the point of intersection of the first marking with the longitudinal center axis to be at a distance from the point of intersection of the further first marking with the longitudinal center axis. This is particularly advantageous when, in the case of different inclination angles of the guide bar, different regions on the redirection section of the guide bar are arranged next to the groove bottom. The points of intersection of the markings with the longitudinal center axis or their extensions are advantageously arranged such that the distance of the marking from that region of the redirection section of the guide bar that is arranged at this inclination angle at the groove bottom is approximately the same for each marking. As a result, comparatively precise estimation of the groove depth is possible. Advantageously, the guide bar has at least two first markings which are arranged in a mirror-symmetrical manner with respect to the longitudinal center axis. As a result, it is possible to estimate the groove depth at inclination angles in both directions with respect to the workpiece surface. In order to be able to estimate different groove depths, at least two first markings which extend parallel to one another are advantageously provided. In particular, a relatively large number of first markings is provided.

In order to be able to estimate the groove depth easily even in the case of a guide bar longitudinal center axis arranged perpendicularly to the workpiece surface, provision is advantageously made for the guide bar to have at least one second marking which extends perpendicularly to the longitudinal center axis. Advantageously, the guide bar has at least one third marking which coincides with the longitudinal center axis in side view. As a result, the inclination angle of the longitudinal center axis of the guide bar to the workpiece surface can be estimated easily, such that comparatively precise incisions at desired incision angles are possible. In order to keep the individual markings distinguishable, provision is in particular made for at least one marking to be indicated by a symbol. This is particularly advantageous when a plurality of markings are provided for different cut depths, which are formed in an identical manner. The symbol can in this case be an abstract symbol, a number, a letter or the indication of the measurement of the incision depth.

The proposed first marking is used particularly advantageously in the case of a guide bar which is used for carving. Such guide bars are known as carving guide bars. In such a guide bar, the redirecting radius at the redirection section of the guide bar is comparatively small. Advantageously, the redirecting radius at the redirection section of the guide bar is smaller than about 30%, in particular smaller than about 25%, preferably smaller than about 20%, of the greatest width, measured perpendicularly to the longitudinal center axis, of the guide bar. In order that the marking remains clearly visible even when the surface is worn, provision is advantageously made for the marking to be in the form of a depression in the guide bar. Advantageously, the top side of the guide bar is painted. The depression advantageously extends through the paint layer as far as the base material of the guide bar. In order to produce the marking, all that is required is to remove the paint layer at the desired regions, for example by way of a laser. It can also be advantageous for the depression to extend into the base material of the guide bar. As a result, the marking is visible even if the paint layer wears away.

For a marking on a guide bar of a chain saw, wherein a saw chain is arranged peripherally on the guide bar, wherein the saw chain is driven by a drive motor of the chain saw, wherein the guide bar has a fastening section at one end and a redirection section at the opposite end, wherein the guide bar has an imaginary longitudinal center axis which extends over the fastening section of the guide bar to the redirection section of the guide bar, wherein the guide bar bears at least one marking in the form of a line, the marking being inclined at an angle of about 20° to about 80° with respect to the longitudinal center axis in side view of the guide bar, provision is made for the first marking to be used in order to estimate, during operation, the depth of a groove produced by the saw chain in the workpiece in the case of a cut in which the longitudinal center axis of the guide bar is inclined at an angle of about 20° to about 80° to the surface of the workpiece.

Since the depth of the groove can be estimated comparatively precisely on account of the marking, depressions having a defined cut depth can be produced. In particular, it is possible to produce depressions having a defined cut depth, in the case of which an incision having the same cut depth is produced at a number of locations on the workpiece and the part exposed in this way from a number of sides is subsequently separated. As a result, very precise work can be carried out with the guide bar, in particular in the case of carving work. The first marking is advantageously used to produce a plurality of grooves or incisions having the same depth. Advantageously, a symbol arranged on the first marking is used to estimate the cut depth.

Advantageously, the guide bar has at least one further first marking, the first marking and the further first marking being inclined with respect to one another and the first marking and the further first marking being used to estimate, during operation, the depth of at least one groove in the case of cuts in which the longitudinal center axis of the guide bar is inclined at different angles to the surface of the workpiece. As a result, a first groove having a first inclination angle of the longitudinal center axis of the guide bar and a second groove having a second, different inclination angle of the guide bar can be produced, these grooves having approximately the same depth.

### BRIEF DESCRIPTION OF THE DRAWINGS

The invention will now be described with reference to the drawings wherein:

FIG. 1 shows a schematic side view of a chain saw;

FIG. 2 shows a schematic sectional view through a detail of the guide bar of the chain saw of FIG. 1;

FIG. 3 shows a side view of the guide bar of the chain saw of FIG. 1;

FIG. 4 shows an enlarged view of the redirecting region and the adjoining section of the guide bar of FIG. 3;

FIG. 5 shows a schematic sectional view through a detail of the guide bar in the region of a marking;

FIG. 6 and FIG. 7 show side views of the front region of exemplary embodiments of guide bars; and,

FIG. 8 and FIG. 9 show schematic views of different positions of the guide bar of FIG. 7 in one or more grooves in a workpiece.

### DESCRIPTION OF THE PREFERRED EMBODIMENTS OF THE INVENTION

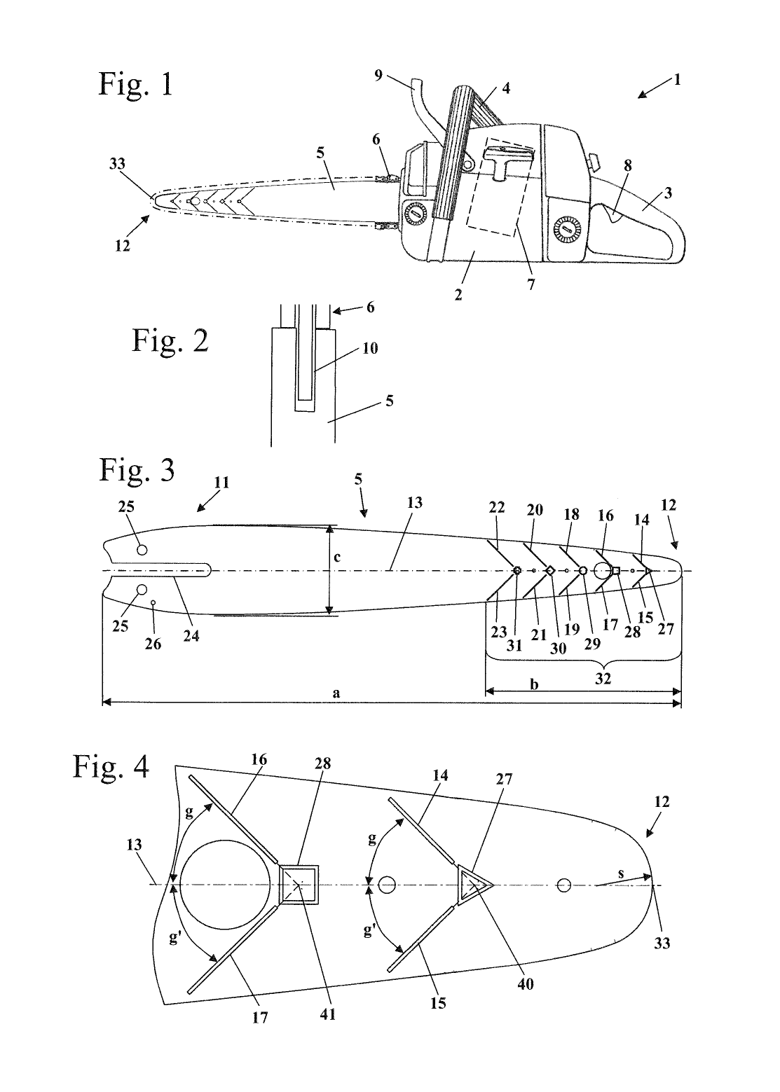

FIG. 1 shows a schematic side view of a chain saw 1. The chain saw 1 has a housing 2 on which a rear handle 3 and a bale handle 4 are fixed. Arranged in the housing 2 is a drive motor 7 which can be an electric motor or an internal combustion engine. If the drive motor 7 is an electric motor, then it is advantageously supplied with power via a power cable or a rechargeable battery. If the drive motor 7 is an internal combustion engine, it is preferably a single-cylinder engine, in particular a two-stroke engine or a mixture-lubricated four-stroke engine.

A throttle lever 8 for operating the drive motor 7 is mounted in a pivotable manner on the rear handle 3. On the side of the housing 2 that faces away from the rear handle 3, a guide bar 5 projects forward, a saw chain 6 being driven peripherally around the guide bar 5. On the side of the bale handle 4 that faces the guide bar 5, a hand protection bracket 9 is arranged, it being possible for the hand protection bracket 9 to be mounted in a pivotable manner on the housing 2 and to trigger a braking device (not shown) for the saw chain 6. The region of the guide bar 5 which faces away from the housing 2 forms a redirection section 12 at which the saw chain 6 is redirected from a movement away from the housing 2 into a movement toward the housing 2. The redirection section 12 includes a tip 33 of the guide bar 5.

As FIG. 2 schematically shows, the saw chain 6 is guided around the periphery of the guide bar 5 in a guide groove 10 of the guide bar 5. The guide groove 10 extends on the outer side of the guide bar 5.

FIG. 3 shows the configuration of the guide bar 5 in detail. The guide bar 5 has a longitudinal center axis 13 which extends from the fastening section 11 of the guide bar to the redirection section 12. Advantageously the guide bar 5 is mirror-symmetrical to a plane containing the longitudinal center axis 13. The fastening section 11 of the guide bar 5 serves for fixing to the housing 2 and has a longitudinal slot 24 through which fastening elements can project. The guide bar 5 has, on both sides of the longitudinal slot 24, fastening openings 25 into which a tensioning device (not shown) for the saw chain 6 can engage. The guide bar 5 also has an oil hole 26 through which oil is fed into the guide groove 10 (FIG. 2), the oil serving to lubricate the saw chain 6 in the guide groove 10.

The guide bar 5 has an overall length a measured parallel to the longitudinal center axis 13 and a greatest width c measured perpendicularly to the longitudinal center axis. The guide bar 5 has a front region 32 which extends from the redirection section 12 over a length b. The length b of the front region 32 is less than half the overall length a of the guide bar 5. Advantageously, the length b is less than approximately 40% of the overall length a. In the front region 32, the guide bar 5 has a multiplicity of markings 14 to 23. The markings 14, 16, 18, 20 and 22 extend parallel to one another and are inclined at an angle g (indicated in FIG. 4) to the longitudinal center axis 13. The angle g is between about 20° and about 80°, in particular between about 20° and about 70°. Advantageously, the angle g is between about 30% and about 60%. In the exemplary embodiment, the angle g is approximately 45°. The marking 15 is arranged in a mirror-symmetrical manner with respect to the marking 14 and is inclined in the opposite direction by an angle g′ to the longitudinal center axis 13. The angle g′ is the same size as the angle g. As FIGS. 3 and 4 show, a symbol 27 is arranged on the markings 14 and 15 in the region of the longitudinal center axis 13. The symbol 27 serves for estimating a first cut depth. In the exemplary embodiment, the symbol 27 is embodied as a triangle. The symbol 27 is arranged such that a point of intersection 40 of the extensions of the markings 14 and 15 is located within the symbol 27.

The marking 17 is arranged in a mirror-symmetrical manner with respect to the marking 16. In the region of the longitudinal center axis 13, the markings 16 and 17 are marked with a symbol 28 which is a square in the exemplary embodiment. The symbol 28 is arranged such that a point of intersection 41 of the extensions of the markings 16 and 17 is located within the symbol 28.

The markings 19, 21 and 23 are arranged in a correspondingly mirror-symmetrical manner with respect to the markings 18, 20 and 22. At the point of intersection of the extensions of the markings 18 and 19, there is arranged a symbol 29 which is embodied as a circle in the exemplary embodiment. At the point of intersection of the extensions of the markings 20 and 21, there is arranged a symbol 30 which is embodied as a diamond. At the point of intersection of the extensions of the markings 22 and 23, there is arranged a symbol 31 which is embodied as a cross. The markings which are assigned to different cut depths are each indicated with different symbols 27 to 31. As a result, a user can easily estimate different cut depths in which the longitudinal center axis 13 is inclined at an angle g or g′ with respect to a surface of a workpiece. In order to estimate the cut depth in the case of a cut in which the longitudinal center axis 13 is arranged perpendicularly to the surface of a workpiece, the symbols 27 to 31 themselves can be used. In the case of inclination angles of the longitudinal center axis 13 of the guide bar 5 with respect to the workpiece surface that differ from the angles g, g′, an approximate estimation of the cut depth can be made on the basis of the markings 14 to 23 and the symbols 27 to 31. The symbols 27 to 31 are located on the longitudinal center axis 13 in side view of the guide bar 5.

The estimation of the cut depth is advantageous in particular in the case of guide bars 5 which are used for carving, that is to say in the case of what are known as carving guide bars. In order to be able to produce fine incisions, the redirecting radius s shown in FIG. 3 at the tip 33 of the guide bar 5 is advantageously as small as possible. The redirection radius s is advantageously less than about 30% of the width c of the guide bar 5, in particular less than about 25%, preferably less than about 20% of the width c. In the exemplary embodiment, the redirecting radius s is about 15% of the width c. On account of the small redirecting radius s and the markings 14 to 23 provided on the guide bar 5, comparatively fine structures can be produced in a comparatively precise manner with the guide bar 5. In this case, the guide bar 5 can be arranged at an angle g or g′ on the workpiece and be pushed into the workpiece at this angle in order to make a cut at the desired angle. It may also be advantageous to arrange the guide bar 5 such that the longitudinal center axis 13 is arranged perpendicularly to the surface of the workpiece and to plunge the guide bar 5 into the workpiece perpendicularly to the workpiece surface and, after reaching the desired incision depth, that is to say when the symbol 27 to 31 assigned to the desired incision depth is located at the workpiece surface, to pivot the guide bar 5 in the cut until the desired inclination angle has been reached, for example up to an angle g or g′.

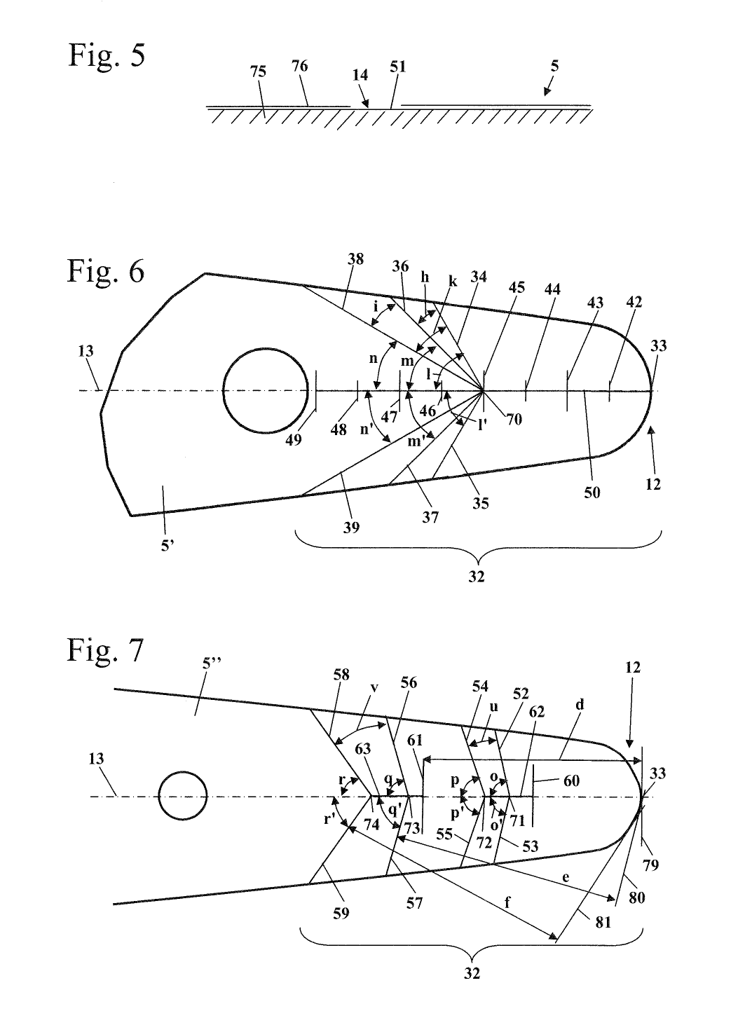

FIG. 5 shows by way of example the configuration of the marking 14 in cross section. The marking 14 is in the form of a depression 51 which is advantageously produced via a laser. The guide bar 5 has a main body 75 which is covered by a paint layer 76. The depression 51 extends advantageously through the entire paint layer 76 as far as the material of the main body 75. During production, the laser advantageously removes the paint layer 76 down to the main body 75. It can also be advantageous for the marking 14 to extend into the material of the main body 75. As a result, the marking 14 is still visible even when the paint layer 76 has been partially or completely removed on account of damage or wear. The markings 14 are very readily visible as a result. Advantageously, the markings 14 to 23 and also the symbols 27 to 31 are embodied as corresponding depressions 51.

FIG. 6 shows an exemplary embodiment of the guide bar 5′ which bears markings 34 to 39 and 42 to 50. The markings 34 and 35 form first markings which are inclined at an angle l, l′ with respect to the longitudinal center axis 13, it being possible for the angle l, l′ to be from about 20° to about 80°. In the exemplary embodiment, the angle l, l′ is advantageously from about 50° to about 70°, in particular approximately 60°. The angle l at which the marking 34 is inclined with respect to the longitudinal center axis 13 is in this case the same size as the angle l′ at which the marking 35 is inclined with respect to the longitudinal center axis 13, but is directed in the opposite direction. The guide bar 5′ has further first markings 36 and 37 which are inclined at an angle m, m′ with respect to the longitudinal center axis 13. The angle m, m′ differs from the angle l, l′ and may be in the range from about 20° to about 80°. In the exemplary embodiment, the angle m, m′ is smaller than the angle l, l′. The angle m, m′ is advantageously about 40° to about 50°. In the exemplary embodiment, the angle m, m′ is about 45°. The guide bar 5′ furthermore has two further first markings 38 and 39 which are inclined at a third angle n, n′ with respect to the longitudinal center axis 13, the third angle n, n′ being smaller than the angle m, m′. The third angle n, n′ is advantageously from about 20° to about 40°. In the exemplary embodiment, the angle n, n′ is about 30°.

The markings 34 and 35, 36 and 37 and the markings 38 and 39 are each arranged in a mirror-symmetrical manner with respect to one another, specifically with regard to a plane containing the longitudinal center axis 13 and arranged perpendicularly to the plane of the guide bar 5′. All of the markings 34 to 39 intersect at a common point of intersection 70 which is located on the longitudinal center axis 13. The markings 34 and 36 and the markings 35 and 37 are inclined at an angle h with respect to one another, the angle being from about 5° to about 40°. In the exemplary embodiment, the angle h is about 15°. The markings 36 and 38 and the markings 37 and 39 are inclined at an angle i with respect to one another, it being possible for the angle i likewise to be from about 5° to about 40°. In the exemplary embodiment, the angle i is also about 15°. By way of the different inclination angles l, m, m′, n, n′ of the markings 34, 35; 36, 37 and 38, 39 with respect to the longitudinal center axis 13, the groove depth can be readily estimated at different inclination angles of the longitudinal center axis 13 to a workpiece surface. The markings 34, 35 are inclined at an angle k to the markings 38, 39, the angle k advantageously being from about 20° to about 50°. In the exemplary embodiment, the angle k corresponds to the sum of the angles h and i.

As FIG. 6 also shows, the guide bar 5′ has second markings 42 to 49 which are arranged perpendicularly to the longitudinal center axis 13. The second markings 42 to 49 are arranged at an increasing distance from the tip 33 of the guide bar 5′. Advantageously, the distance between adjacent second markings 42 to 49 is in each case the same size. By way of the second markings 42 to 49, the cut depth can be readily estimated when the longitudinal center axis 13 is arranged perpendicularly to the workpiece surface. The second marking 45 in this case contains the point of intersection 70 of the first markings 34 to 39. The guide bar 5′ also has a third marking 50 which coincides with the longitudinal center axis 13 of the guide bar 5′ in the side view shown. In order to estimate cut depths which deviate from the cut depth indicated by the second marking 45′ in the case of a longitudinal center axis 13 arranged obliquely with respect to the workpiece surface, the user can arrange the guide bar 5′ such that one of the markings 34 to 39 comes to lie parallel to the workpiece surface and the workpiece surface intersects that point of intersection of the markings 42 to 49 with the third marking 50 that corresponds to the desired cut depth. It is also possible in the case of the guide bar 5′ for one or more symbols additionally to be provided at one or more of the markings 34 to 39 and 42 to 49, the symbols indicating the cut depth to the user.

A further exemplary embodiment of the guide bar 5″ is shown in FIG. 7. The guide bar 5″ has first markings 52 to 59 which are inclined with respect to the longitudinal center axis 13. The first markings 52 and 53 are inclined at an angle o, o′ with respect to the longitudinal center axis 13, the angle o, o′ being from about 20° to about 80°. In the exemplary embodiment, the angle o, o′ is from about 70° to about 80°. The marking 52 is in this case inclined at the angle o and the marking 53 is inclined at the angle o′ which is the same size but directed in the opposite direction. The markings 54 and 55 are further first markings which are inclined at an angle p, p′ with respect to the longitudinal center axis 13, the angle p, p′ being smaller than the angle o, o′. The angle p, p′ is advantageously from about 45° to about 75°. In the exemplary embodiment, the angle p, p′ is from about 65° to about 75°. The markings 52 and 53 are arranged in a mirror-symmetrical manner with respect to one another. Likewise, the markings 54 and 55 are arranged in a mirror-symmetrical manner with respect to one another. The angle p′ at which the marking 55 is inclined with respect to the longitudinal center axis 13 is the same size as the angle p at which the marking 54 is inclined, but is inclined in the opposite direction with respect to the longitudinal center axis 13. Formed between the markings 52, 53 and 54, 55 is an angle u which is from about 5° to about 40°. In the exemplary embodiment, the angle u is approximately 5°.

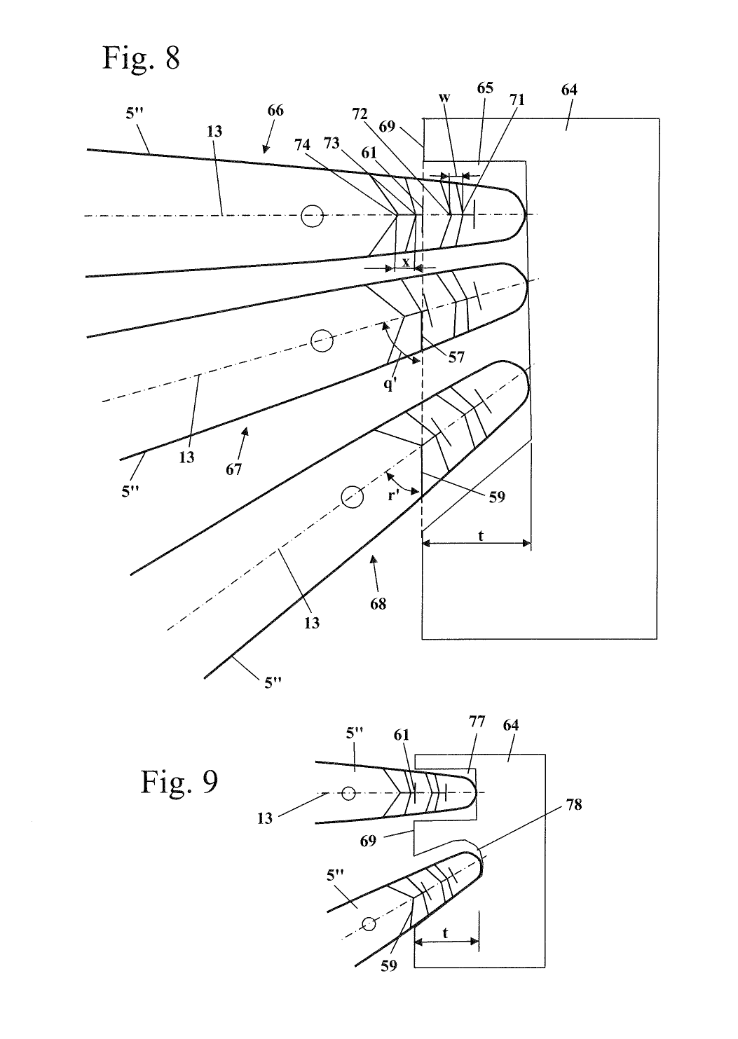

The first markings 52, 53 intersect the longitudinal center axis 13 at a point of intersection 71. The further first markings 54 and 55 intersect the longitudinal center axis 13 at a point of intersection 72 which is at a distance w from the point of intersection 71. The distance w is indicated for better clarity in FIG. 8. As FIG. 7 shows, the guide bar 5″ has a second marking 60 which is arranged perpendicularly to the longitudinal center axis 13 and which is located between the point of intersection 71 and the tip 33 of the guide bar 5″. The points of intersection 71 and 72 and the point of intersection of the second marking 60 with the longitudinal center axis 13 are connected together by a third marking 62. The second marking 60 is in this case at the smallest distance from the tip 33 of the guide bar 5″. The point of intersection 71 of the markings 52 and 53 is located between the point of intersection 72 of the markings 54 and 55 with the point of intersection of the second marking 60 with the longitudinal center axis 13. The third marking 62 coincides with the longitudinal center axis 13 in side view of the guide bar 5″.

The markings 52 to 55, 60 and 62 are connected together and form a marking arrangement which repeats in an identical or similar manner at increasing distance from the tip 33 of the guide bar 5″. In the exemplary embodiment, the guide bar 5″ has first markings 56 and 57 which are inclined at an angle q, q′ with respect to the longitudinal center axis 13. The angle q, q′ can be from about 20° to about 80°. The angle q, q′ can advantageously correspond to the angle o, o′. In the exemplary embodiment, the angle q, q′ is somewhat smaller than the angle o, o′ and is from about 60° to about 75°. Advantageously, the angle q, q′ is greater than about 45°. The markings 56 and 57 are arranged in a mirror-symmetrical manner with respect to one another and intersect at a point of intersection 73 on the longitudinal center axis 13. The marking 56 is in this case inclined at the angle q and the marking 57 is inclined at the angle q′ which is the same size but directed in the opposite direction. The guide bar 5″ has two further first markings 58 and 59 which are inclined at an angle r, r′ with respect to the longitudinal center axis 13, the angle r, r′ being smaller than the angle q, q′. The angle r, r′ is advantageously from about 30° to about 60°. In the exemplary embodiment, the angle r, r′ is about 50° to about 60°. In this case, the marking 58 is inclined at the angle r and the marking 59 is inclined at the angle r′ which is the same size but directed in the opposite direction. The further first markings 58 and 59 intersect at a point of intersection 74 on the longitudinal center axis 13. The distance of the point of intersection 74 from the tip 33 of the guide bar 5″ is greater than the distance of the point of intersection 73 from the tip 33. The points of intersection 73 and 74 are at a distance x which is indicated in FIG. 8. The markings 56 and 58 enclose an angle v which is from about 5° to about 40°. In the exemplary embodiment, the angle v is approximately 20°. The guide bar 5″ also has a further second marking 61 which is arranged perpendicularly to the longitudinal center axis 13. The further second marking 61 is arranged on that side of the markings 56 to 59 which faces the tip 33. The guide bar 5″ also has a further third marking 63 which coincides with the longitudinal center axis 13 in side view. The third marking 63 connects the points of intersection 74 and 73 with the point of intersection of the second marking 61 with the longitudinal center axis 13.

In FIG. 7, the distance d of the second marking 61 from the tip 33 of the guide bar 5″ is indicated. The distance d corresponds to the depth of a groove which is produced with a longitudinal center axis 13 arranged perpendicularly to the workpiece surface when the marking 61 is located at the workpiece surface. The bottom of the groove is schematically indicated by way of a line 79 in FIG. 7. If the longitudinal center axis 13 is inclined by the angle q′ with respect to the workpiece surface and the guide bar 5″ is arranged such that the first marking 57 coincides with the workpiece surface, then a groove is produced, the base of which is indicated by a line 80. The line 80 is at a distance e from the marking 57, the distance d advantageously corresponding approximately to the distance d. A line 81 is indicated parallel to the marking 59 at the redirection section 12. The line 81 is at a tangent to the redirection section 12, as are the lines 80 and 79. The line 81 is at a distance f from the marking 59. If the longitudinal center axis 13 is arranged at an angle r′ with respect to the workpiece surface and the guide bar 5″ is introduced into the cut until the workpiece surface is located at the marking 59, a cut is produced having a depth which corresponds to the distance f. The distances d, e and f are advantageously approximately the same size. The differences in the distances d, e and f are in particular provided in order to produce a sufficiently large distance between the markings 52 to 55 and 60 and 56 to 59 and 61, such that the latter can be visually distinguished more easily. On account of the approximately identical distances d, e and f, cuts having an approximately identical depth can be produced by way of the markings 56 to 59 and 61.

FIGS. 8 and 9 show examples of cuts produced with the guide bar 5″. FIG. 8 schematically shows a workpiece 64 in which the guide bar 5″ has produced a groove 65.

The guide bar 5″ is shown in a first position 66 in which the marking 61 is arranged in line with the surface 69 of the workpiece 64. The longitudinal center axis 13 of the guide bar 5″ is arranged in the position 66 perpendicular to the surface 69. The guide bar 5″ produces a cut having a depth t. In a second position 67, the guide bar 13 is inclined at an angle q′ to the surface 69. The marking 57 is arranged in line with the surface 69. In this position, too, the guide bar 5″ produces a groove 65 having the depth t. In a third position 68, the longitudinal center axis 13 is inclined at an angle r′ to the surface 69, the angle r′ being smaller than the angle q′. The marking 59 is arranged in line with the surface 69. In this position 68 of the guide bar 5″, too, the groove 65 produced has a depth t. In order to produce the groove 65, the guide bar 5″ can be plunged perpendicularly into the workpiece until the guide bar 5″ is in the position 66. Subsequently, the guide bar 5″ can be pivoted in the cut until the desired inclination angle has been reached, for example via the position 67 to the position 68. In order to produce the groove 65, the guide bar 5″ is also moved laterally. Provision can also be made to pivot the guide bar 5″ only in order to produce a desired groove.

As FIG. 9 schematically shows, different grooves 77 and 78 having different incision angles, the grooves having approximately the same depth t, can be produced with the guide bar 5″. In order to produce the groove 77, the longitudinal center axis 13 of the guide bar 5″ is arranged approximately perpendicularly to the surface 69 and is plunged in perpendicularly to the surface 69 of the workpiece 64. In order to produce the groove 78, the guide bar 5″ is arranged in the position 68 and then the guide bar 5″ is moved in the direction of the longitudinal center axis 13 until the marking 59 is oriented at the surface 69 and the desired depth t has been reached. In this case, the marking 59 serves during the entire incision operation for orienting and estimating the incision angle. The groove 78, too, the side walls of which are inclined at an angle other than 90° with respect to the surface 69, has a depth t. The markings on the guide bar 5, 5′, 5″ are in this case each used to estimate the depth t of the groove.

It is understood that the foregoing description is that of the preferred embodiments of the invention and that various changes and modifications may be made thereto without departing from the spirit and scope of the invention as defined in the appended claims.

1-17. (canceled)

18. A guide bar for a saw chain of a chain saw comprising:
a guide bar body defining an imaginary longitudinal center axis and having a first end and a second end disposed opposite to said first end;
said first end having a fastening section;
said second end having a redirecting section;
said imaginary center line extending from said fastening section to said redirecting section; and,
at least one first marking having a linear shape and being inclined at an angle lying in a range of approximately 20° to approximately 80° with respect to said imaginary longitudinal center axis when said guide bar body is viewed in side elevation.

19. The guide bar of claim 18, wherein:
said guide bar body has a total length (a) and defines a forward region extending from said redirecting section over at most half of said total length (a); and,
said first marking is arranged in said forward region of said guide bar body.

20. The guide bar of claim 18 further comprising:
a further first marking; and
said first marking and said further first marking being inclined with respect to one another.

21. The guide bar of claim 20, wherein said first marking and said further first marking conjointly enclose an angle (h) lying in a range of approximately 5° to approximately 40°.

22. The guide bar of claim 20, wherein said first marking and said further first marking intersect at said longitudinal center axis.

23. The guide bar of claim 20, wherein:
said first marking intersects said longitudinal center axis at a first intersection point;
said further first marking intersects said longitudinal center axis at a second intersection point; and,
said first intersection point is at a distance (w) from said second intersection point.

24. The guide bar of claim 18 further comprising:
a second marking; and,
said first and said second marking being arranged in a mirror-symmetrical manner with respect to said longitudinal center axis.

25. The guide bar of claim 18 further comprising two first markings running parallel to each other.

26. The guide bar of claim 18 further comprising a second marking running perpendicular to said longitudinal center axis.

27. The guide bar of claim 18 further comprising a third marking which coincides with said longitudinal center axis.

28. The guide bar of claim 18, wherein said first marking is indicated by a symbol.

29. The guide bar of claim 18, wherein:
said redirecting section defines a redirection radius (s);
said guide bar body has width (c) measured perpendicular to said longitudinal center axis; and,
said redirection radius (s) is less than 30% of the greatest value of said width (c).

30. The guide bar of claim 18, wherein said first marking is configured as a recess in said guide bar body.

31. Method of using a marking on a guide bar of a chain saw having a saw chain peripherally arranged about the guide bar, a drive motor configured to drive said saw chain, the guide bar having a fastening section at one end thereof and a redirecting section at the opposite end thereof, the guide bar defining an imaginary longitudinal center axis which extends from the fastening section to the redirecting section, the guide bar further having at least one first linearly shaped marking which, when viewing the guide bar in side elevation, is inclined at an angle (g) lying in a range of approximately 20° to approximately 80° with respect to the longitudinal center axis; the method comprising the steps of:
during operation, using the first marking to estimate the depth (t) of a groove generated in a workpiece by the saw chain during a cut wherein the longitudinal center axis of the guide bar is inclined at an angle (q) lying in a range of approximately 20° to approximately 80° with respect to a surface of the workpiece.

32. The method of claim 31 further comprising the step of using the first marking to make a plurality of grooves having a depth corresponding to said depth (t).

33. The method of claim 31, wherein the guide bar further has a symbol arranged on said first marking; and, wherein the symbol is used to estimate the depth (t) of a cut.

34. The method of claim 31, wherein the guide bar has a further first marking which is inclined with respect to the first marking, wherein, during operation, the first marking and the further first marking are used to estimate the depth (t) of at least one groove generated in a workpiece when cutting wherein the longitudinal center axis of the guide bar is inclined at different angles (q, q′; r, r′) with respect to a surface of the workpiece.
